(19) United States
(12) Patent Application Publication
(10) Pub. No.: US 2001/0050091 A1
(43) Pub. Date: Dec. 13, 2001

(54) Method apparatus of disc burnishing with a glide/burnish head

(75) Inventors: Wei Hsin Yao, Fremont, CA (US); Ramesh Sundaram, Fremont, CA (US); Li-Ping Wang, Fremont, CA (US); Chiao-Ping Ku, Fremont, CA (US)

Correspondence Address: Attention: Natalie D. Kadievitch, MERCHANT & GOULD P.C., P.O. Box 2903, Minneapolis, MN, 55402-0903, US

(73) Assignee: Seagate Technology LLC, Scotts Valley, CA (US)

(21) Appl. No.: 09/899,597

(22) Filed: Jul. 5, 2001

Related U.S. Application Data
(63) Continuation of application No. 09/272,183, filed on Mar. 18, 1999.
(60) Provisional application No. 60/078,550, filed on Mar. 19, 1998.
(60) Provisional application No. 60/078,625, filed on Mar. 19, 1998.

(51) Int. Cl. B08B 7/04; B23K 26/00; B23K 26/02; B23K 26/08

(52) U.S. Cl. 134/1.3; 134/1; 134/5; 134/18; 356/369; 219/121.6; 219/121.61; 219/121.62; 219/121.78; 219/121.83; 134/902

(57) ABSTRACT

Cleaning a media surface, such as a disc surface, comprises subjecting the surface to a detector for sensing the nature of the surface for an irregularity in the smoothness of the surface. Directing, on detecting an irregularity beyond a predetermined amount, a burnishing pulse laser output to that irregularity, and energizing the laser to thereby impart an energy source to reduce the irregularity to a degree less than a predetermined amount.

### CROSS-REFERENCE TO RELATED APPLICATIONS

The present invention relates to Provisional Application Ser. No. 60/078,550, filed Mar. 19, 1998, by Wei Yao, et al., entitled “DISC BURNISHING WITH LASER” and Provisional Application Ser. No. 60/078,625, filed Mar. 19, 1998, by Istvan M Boszormenyi, entitled “INTEGRATED LASER CLEANING AND INSPECTION SYSTEM”. The contents of these applications are incorporated by reference herein.

### BACKGROUND OF THE INVENTION

This invention relates to laser cleaning and inspecting of surfaces. In particular the system is for use on disc surfaces which are used for recording data.

In most high technology industries, for instance, semiconductor device, hard disc or flat panel display manufacturing, improved performance is linked to the ability to reduced the feature size. Thus, there is the narrower line width, smaller bit cell or pixel size. As a consequence, the size of detrimental contamination, for example, particles, steadily decreases. Hence, there is an increased demand for effective cleaning technologies, tools and processes. To reduce cost these cleaning processes need to be monitored closely.

Laser cleaning has emerged as a potential new dry cleaning technology to remove particles and other contaminants from surfaces. With the increase of disc drive storage area density, the fly height of a slider decreases substantially. The ability to manufacture and test high quality rigid disc media without defects or asperities becomes essential as stated by Hung-Wei Chen, et al. in IEEE Transactions on Magnetics, Vol. 33, No. 5, pp. 3103-3105, 1997.

During a glide test, a PZT slider flies over the media and if any hit is detected, a waffle-burnish head is used to remove the source of the hit. This process typically requires at least two passes over the surface of the disc; namely, one to identify the defect and one to remove the defect.

One problem with the use of the burnish-head is related to the cleanliness of the burnish head. In most environments it is difficult to determine whether the burnish head is clean. Indeed, in the media production, a dirty burnish head would only be discovered after it starts to crash discs. In addition, the debris from the burnishing process sometimes stay on the media surface and become a secondary source of head-disc-interference, namely a crash.

A need exists for an improved technique for cleaning surface such as discs that provides a cleaner burnish source. Further, a need exists in the industry for a more efficient technique for cleaning surfaces wherein the amount of time required to detect and remove the defect is minimized.

### SUMMARY OF THE DISCLOSURE

Preferred embodiments of the invention are directed to a method, system and apparatus for cleaning a media surface, such as a rigid disc surface, and comprises subjecting the surface to a detector for sensing the nature of the surface for an irregularity in the smoothness of the surface. When an irregularity beyond a predetermined amount is detected, a burnishing pulse laser output is directed to that irregularity. The laser is energized to thereby impart an energy source to reduce the irregularity to a degree less than the predetermined amount.

### BRIEF DESCRIPTION OF THE DRAWINGS

FIG. 1 is shows the configuration of laser burnishing

FIG. 2 depicts a preferred embodiment of a glide head, having a focusing apparatus which includes an optical fiber, mirrors and a lens.

### DETAILED DESCRIPTION OF THE PREFERRED EMBODIMENT

In the following description, reference is made to the accompanying drawings which form a part hereof, and which show, by way of illustration, several embodiments of the present invention. It is understood that other embodiments may be utilized and structural changes may be made without departing from the scope of the present invention.

In preferred embodiments of the present invention, a rigid disc is laser burnished with a pulse laser. A slider having a glide head is passed over the surface of a disc. When the glide head, namely a detector, detects an asperity or defect on the surface of the disc, the glide head vibrates and deforms. Laser pulses are then guided to the spot for burnishing or removal. The power of the laser can be controlled to remove the source of the asperity or defect, namely the irregularity.

The term “burnishing” refers to a process which rubs or polishes the surface by smoothing out irregularities which are encountered. In the context of this disclosure, this term further includes ablation, vaporization and breaking of irregularities into smaller pieces.

In addition to removing asperities, the laser can be used to read back the surface morphology, which is then used as a feedback regarding the status of the removal of the asperity. If the burnish action has not reduced the defect to a desired size or height, the laser can be redirected and commence burnishing the same spot again. A burnishing process is effected to thereby reduce, preferably remove, the irregularities and minimize residue on the disc surface.

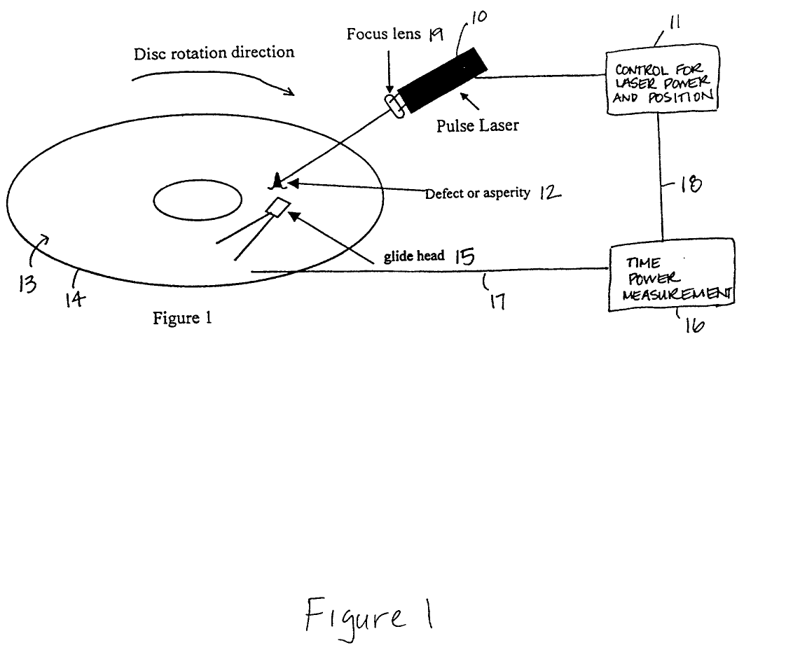

With reference to FIG. 1, the media surface cleaning system comprises a laser control means 11 and a laser 10, such as a pulse laser. The laser control means 11 varies the power of the laser output for either reading the disc or effecting reduction of the irregularity, defect or asperity 12 on a surface 13 of a disc 14. The media surface cleaning system further comprises a glide head 15 for measuring the irregularity and a control means 16 for determining the time and power necessary to effect burnishing for reduction of the irregularity 12. The control means 16 are in electronic communication via feed back means 17, 18 with the glide head 15 and the laser control means 11 such that the necessary burnish information is transmitted from the glide head 15, which detects the defects on the surface, to the laser control means 11, which governs the removal of the defects. The feed back means 17, 18 output measurements of the irregularity 12 to the control means 11 for regulating the power of a laser 10 so that the irregularity 12 is effectively reduced to a predetermined amount, including, but not limited to, a predetermined height. The output of the laser 10 is directed through a focusing lens 19 to the surface 13 of the disc 14.

The laser output and glide head position are moved over the disc surface in a conventional manner. Thus, a suitable voice coil can have the glide head in a conventional pivoted fashion over the disc 14, and the control 11 can operate a motor to position the laser 10 appropriately.

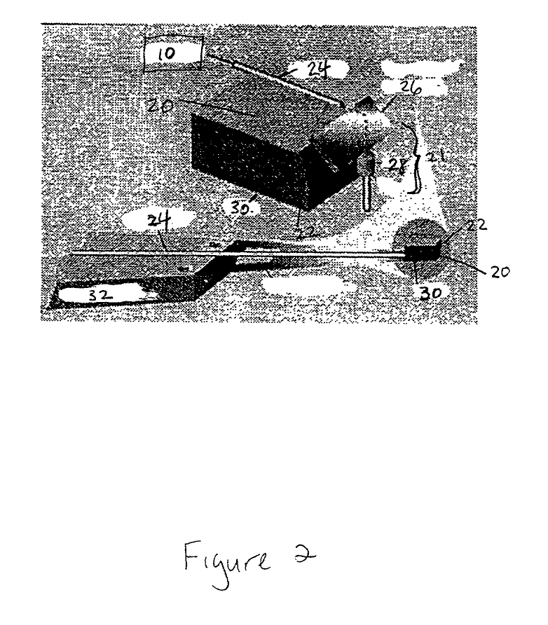

FIG. 2 depicts another preferred embodiment of a glide head. The glide head, which is mounted on a slider 30, is coupled to an actuator arm 32 of a disc drive assembly (not shown). In one preferred embodiment, the glide head 20 comprises a piezoelectric transducer, wherein the size, shape and mounting of the glide head on the slider is dependent upon the desired usage.

With reference to FIG. 2, the glide head 20 comprises a body having a leading end 22, and a focusing apparatus 21 including an optical fiber 24, mirrors 26 and a lens 28. The optical fiber 24 extends from an energy source 10, such as a laser 10, to the leading end 22 of the body. The optical fiber 24 is aligned with the laser 10 such that the energy or light from the laser can be directed and focused.

The mirrors 26 are micro-machined mirrors and reside adjacent the leading end 22 of the glide head 20. The mirrors are in alignment with the optical fiber 24 such that the light conducted through the optical fiber 24 is directed onto the mirrors 26. The mirrors are angled such that they are capable of reflecting the light from the optical fiber 24 onto the surface 13 of the disc 14.

The lens 28 resides adjacent the mirrors 26 such that the light conducted through the optical fiber 24 and reflected from the mirrors 26 can be focused through the lens 28 and onto the surface 13 of the disc 14. In this manner, any detected asperities can be eliminated via the light focused onto the surface of the disc.

The configuration of the glide head 20 shown in FIG. 2 allows control of the laser power such that the laser 10 can be used to read the disc 14 or burnish the surface 13 of the disc 14. In operation, during the use of this glide head 20, a single pass over the disc 14 is made. During this single pass, the glide head 20 detects asperities or defects on the disc surface 13 of the disc 14 and eliminates the asperities or defects.

The following describes other alternative embodiments for accomplishing the present invention. For example, any number of different types of surfaces could be used with the present invention. Those skilled in the art will recognize that the present invention could be applied to both magnetic and optical disk drives.

In another example, surfaces having different structures and components from those described herein could benefit from the present invention. Those skilled in the art will recognize that the system, method and apparatus could have a different steps and structures from that disclosed herein without departing from the scope of the present invention. Also, different kinds of lasers can be used. A single laser can be used for burnishing and for feedback of the irregularities, or multiple lasers can be used, for instance, one for burnishing and another for feedback of measurements of disc surface irregularities.

The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto.

What is claimed is:

1. A method of cleaning a media surface comprising:
subjecting the surface to a detector for sensing the nature of the surface for an irregularity in the smoothness of the surface;
directing, on detecting an irregularity beyond a predetermined amount, a burnishing laser output to that irregularity; and
energizing the laser to thereby impart an energy source to reduce the irregularity to a degree less than a predetermined amount.

2. A method as claimed in claim 1 wherein the laser output is from a pulse laser.

3. A method as claimed in claim 1 wherein a burnishing process is effected to thereby reduce, preferably remove, the irregularities and minimize residue on the disc surface.

4. A method as claimed in claim 1 including varying the power of the laser output for effecting reduction of the irregularity.

5. A method as claimed in claim 1 including measuring the irregularity and determining the time and power necessary to effect burnishing for reduction of the irregularity.

6. A method as claimed in claim 5 including feeding back measurements of the irregularity as an output to thereby regulate the laser power so that the irregularity is effectively reduced to a predetermined amount.

7. A method as claimed in claim 1 wherein the media surface is a rigid disc surface.

8. An apparatus for cleaning a media surface comprising:
a detector for sensing the nature of the surface for an irregularity in the smoothness of the surface;
a burnishing laser for direction to that irregularity on detecting an irregularity beyond a predetermined amount; and
means for energizing the laser to thereby impart an energy source to reduce the irregularity to a degree less than a predetermined amount.

9. Apparatus as claimed in claim 8 wherein the laser output is from a pulse laser.

10. Apparatus as claimed in claim 8 including means for varying the power of the laser output for effecting reduction of the irregularity.

11. Apparatus as claimed in claim 8 including means for measuring the irregularity and means for determining the time and power necessary to effect burnishing for reduction of the irregularity.

12. Apparatus as claimed in claim 11 including means for feeding back measurements of the irregularity as an output to thereby regulate the laser power so that the irregularity is effectively reduced to a predetermined amount.

13. An apparatus for cleaning a media surface comprising:
a detector for sensing the nature of the surface for an irregularity in the smoothness of the surface, wherein the detector includes a laser focusing apparatus;
a burnishing laser for direction to that irregularity on detecting an irregularity beyond a predetermined amount; and
means for energizing the laser to thereby impart an energy source to reduce the irregularity to a degree less than a predetermined amount.

14. An apparatus as claimed in claim 13, wherein the laser focusing apparatus comprises an optical fiber, a mirror and a lens, wherein the optical fiber, the mirror and the lens are aligned such that the energy source is focused to the media surface.

15. A glide head coupled to an actuator arm of a glide/burnish media tester for detecting asperities and defects in a media surface and for removing the asperities and defects from the media surface, the glide head comprising:
a body having a leading end;
an optical fiber, wherein the optical fiber extends from an energy source adjacent the actuator arm to the leading end of the body, the optical fiber being configured to conduct an energy from the energy source;
a mirror disposed on the leading end of the body, wherein the mirror is configured to reflect the energy from the energy source onto the surface of the media; and
a lens disposed adjacent the mirror, wherein the lens is aligned with the mirror and the optical fiber such that the energy from the energy source is focused through the lens onto the media surface.
